(19) United States
(12) Patent Application Publication
(10) Pub. No.: US 2011/0291815 A1
(43) Pub. Date: Dec. 1, 2011

(54) METHOD AND APPARATUS FOR CONFIGURING A TAG

(76) Inventor: Jeroen van Bemmel, The Hague (NL)

(21) Appl. No.: 13/143,893

(22) PCT Filed: Jan. 10, 2010
(86) PCT No.: PCT/IB2010/000541

§ 371 Date: Aug. 15, 2011

(30) Foreign Application Priority Data
Jan. 14, 2009 (EP) 09290030.7

(51) Int. Cl. G06K 7/01

(52) U.S. Cl. 340/10.6; 340/10.1

(57) ABSTRACT

A source is able to configure a tag, such as an RFID tag, associated with it such that, when the tag is read, a responsive action is initiated. The responsive action may be detectable by the source or may be a message shown to a person reading the tag, for example. In one example, information is provided concerning delivery of a physical object from the source to a destination. The source may associate the tag with the physical object. The tag may be configured such that, when the tag is read at the destination, it causes a responsive action, which is detectable by the source.

### FIELD OF THE INVENTION

The present invention relates to a method and apparatus for configuring a tag, and more particularly, but not exclusively, to method and apparatus for providing information concerning delivery of a physical object from a source to a destination.

### BACKGROUND

Radio frequency identification (RFID) tags are used to identify, track or monitor physical objects with which they are associated. Communication with the tag, to read or modify data carried by the tag, is implemented using electromagnetic or electrostatic coupling at radio frequencies, with low frequency devices having a shorter range than higher frequency ones.

### BRIEF SUMMARY

According to an aspect of the invention, a method for configuring a tag by a source associates information with it to control an event when the tag is read by a recipient.

The tag may be an RFID tag but tags based on other technologies may be employed. In one embodiment, the tag is a passive tag that is attached by the source to the object. One convenient type of tag for this purpose includes an adhesive backing enabling it to be readily attached to a suitable surface. In one embodiment, the tag might be integrated into packaging material included as part of the object, for example.

Using a method in accordance with the invention, Information may be provided concerning delivery of a physical object from the source to a destination, including the source associating the tag with the physical object, the tag being configured such that, when the tag is read at the destination, it causes a responsive action, the responsive action being detectable by the source. A tag is associated with the person that uses it (“source”) and to associate information with it that controls what happens when the tag is read, e.g. by a recipient (“destination”) of a package or letter. What happens is configurable online, and can be changed. Also associated with the tag is a context that the source can use to differentiate between the various tags that he or she has “unleashed” in the physical world.

The source may configure the tag via a remote access, such as via the internet.

In one embodiment, the responsive action is at least one of: an acknowledgement of receipt of the tag at a destination; sending information about the location where the tag has been read; informing the source that the tag has been read; informing a destination that the tag has been read; displaying a message to a person reading the tag.

In one embodiment, the source configures the tag with information that includes at least one of: information about the source; information about the context of the tag; and information about a destination.

The source may configure the tag in an embodiment, such that, when the tag is read, a responsive action is initiated, and the responsive action is dependent on the identify of an entity reading the tag. Thus an authorized person may be given one message and an unauthorized person another message.

### BRIEF DESCRIPTION OF THE DRAWINGS

Some embodiments of the present invention will now be described by way of example only, and with reference to the accompanying drawings, in which:

FIG. 1 schematically illustrates one method in accordance with the invention;

FIG. 2 schematically illustrates one method in accordance with the invention;

FIG. 3 schematically illustrates one method in accordance with the invention; and

FIG. 4 schematically illustrates a tag in accordance with the invention.

### DETAILED DESCRIPTION

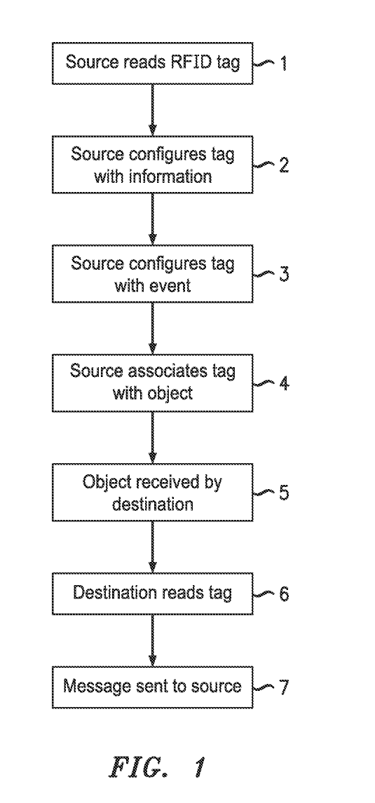

With reference to FIG. 1, in one embodiment, a first user, termed the source, wants to send a letter, or other physical object, to a second user, termed the destination. The source configures an RFID tag by reading the tag using an RFID reader, as shown at 1, and editing the configuration of the tag using a software application, shown at 2, to include information.

The source configures the tag to include three classes of information: information about the source; information about the context of the communication effected by sending the object; and information about the destination. The information about the source may include, for example, a link to the first user's online profile, e-mail address and/or telephone number so as to identify and/or provide a means of contacting the source. The information about the context of the communication may provide information concerning, for example, the subject matter of the letter, a reference number or some other data to assist the destination in understanding the relevance of the object. The information about the destination may include identification data regarding the intended recipient.

At step 3, the user also configures the tag with a responsive action, which may also be termed an event, to be carried out when the tag is read. More than one event may be configured to be carried out when the tag is read. The source configures the tag to cause an SMS text message to be sent to the source when a particular intended destination uses a reader to scan the tag. In this particular embodiment, the source configures the tag to carry out an event that is dependent on which entity might read the tag, so as to provide different events for different entities. If someone other than the intended recipient reads the tag, a message is sent to the source to alert them to attempted access by someone other than the intended recipient and, depending on the functionality of the tag and/or reader, a message may be displayed to the person informing them that they are not authorized to receive the letter.

After configuring the tag, the source attaches the tag to the letter, at step 4. The tag may also serve as the “digital signature” of the sender.

The destination receives the letter and associated tag, at step 5. When the intended recipient reads the tag at step 6, the event is triggered and a text message is sent to the source, at step 7. The text is sent directly to the source. The source is thus able to detect that the tag has been read at the destination. In another embodiment, the message is sent to another location that may be accessed by the source to detect the responsive action.

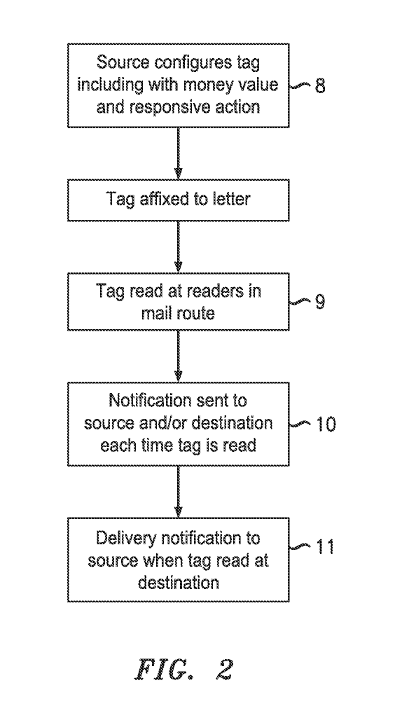

In another embodiment, illustrated in FIG. 2, a tag is used as a postal stamp for a letter and is associated with a monetary value. The tag is configured by the source with an appropriate amount of money at 8 and with a responsive action so as to report back to the source via a text message, or other means, each time the tag is read. The tag is attached to a letter. The letter passes through tag readers distributed throughout the mailing system to verify that sufficient credits remain at each stage of the mailing system, as shown at 9. At each stage, the tag is read by a reader operated by the post office and the monetary value checked against pricing policies. The source and destination may receive notifications concerning progress of the letter, shown at 10. The source may configure the tag to also report to the destination or to only report to the destination. The report may include information such as the physical location of the reader, for example, its GPS or latitude/longitude coordinates, and/or timestamp data. The source may thus configure the system to receive notifications about the progress the letter makes on its way to the recipient. When the mailman finally delivers the letter, he scans the tag with his portable reader, and the sender gets an acknowledgement that the letter has been delivered, at step 11.

A tag of the type having an adhesive backing may additionally be used to seal a letter, in addition to the other configured functions set by the source.

A tag may be configured by a source with information about an object for sale and configured to send notification to the source when the tag is read. The tag may be placed on a bulletin board, for example, in a local store when advertising the object for sale. A potential buyer may read the tag, using their own reader or one provided by the store, triggering a notification to the source. A message is sent to the source and contact information is made available to the potential buyer.

A source may configure a tag so as to initiate a phone call, video call, send an e-mail, IM, or some similar action when the tag is read, subject to the identity of the reader and/or identity of the person associated with the reader and tag being compatible with the conditions configured by the source.

A source may configure a tag with a message to be displayed, for example, for the recipient, but also for other people, for example, “This letter is not for your eyes” when anyone else besides the intended recipient scans the tag. The message may be displayed on the reader.

A tag may be used as a marketing tool. For example, leaflets containing tags may be distributed by a source. The source is given an indication of interest by configuring each tag to send a notification to the source whenever the tag is read, including—if available—information about person(s) associated with the reader. The tag can also be configured to cause a message to be displayed to the person scanning the tag, such as, for example, when he/she uses a mobile phone to read the tag, “click here to call us”.

A software system for managing previously “released” tags may be implemented on a home gateway, for example. Tags may be configured to send their read events to this gateway, for example, to start a video call between the person reading the tag and the household or business in which the gateway is located.

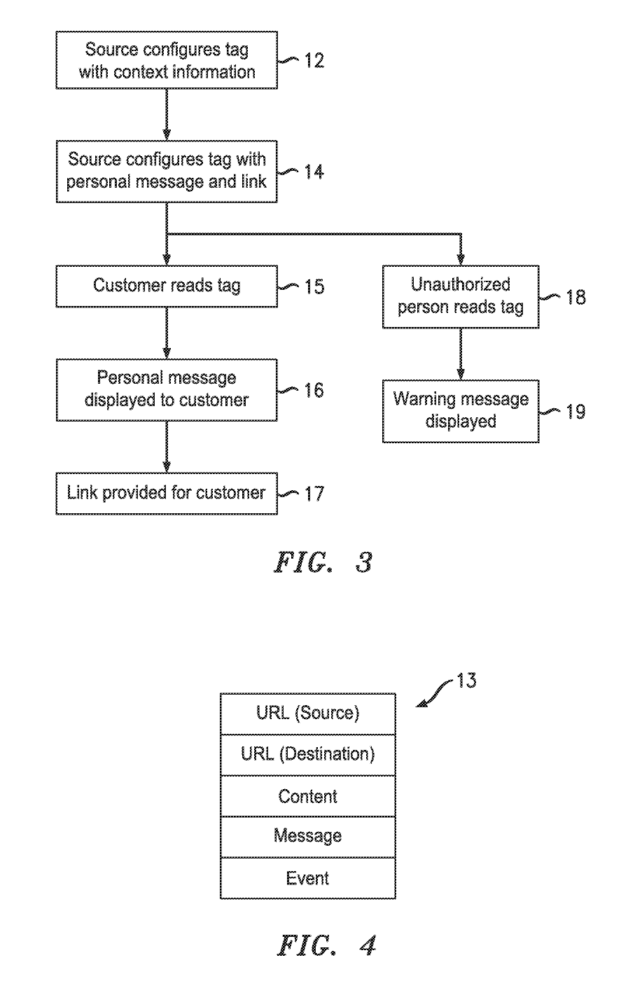

With reference to FIG. 3, a source writes a letter to a customer and, at 12, configures a tag 13, shown in FIG. 4, associated with the letter. The tag 13 is configured with the subject/context of the letter (“exciting new communication vision”), the identity of the source, such as a URL to source profile on LinkedIn, or some other networking site, and the identity of the intended recipient (for example, URL/id/e-mail of the customer.) The source also configures a personal message, 14, to be displayed to the customer when the customer reads the tag 13, and an event to be sent back to him, for example, via e-mail, when the tag 13 is read. The source sticks the tag 13 onto the printed letter.

When the intended recipient reads the letter at 15 and scans the tag 13 with his reader, which may be, for example, built-in into a mobile device having other functions, he sees the personal message 16 from the source. The source receives an e-mail informing him that the customer has read his letter. The customer can also verify that the letter is from the source. When someone else 18 reads the tag 13, he gets a message “You are not the intended recipient”, 19, perhaps in the language associated with the person reading the tag 13, and an event is sent to the source that someone whom he did not intend read his tag 13.

The source may include a communication link 17 which, when clicked on or read by the intended recipient, seeks to initiate communication, for example, via a video call. Then the customer can click to accept if he wishes to make immediate contact, or click on “postpone until later” instead, and schedule a mutually agreeable time.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of configuring a tag associated with a source, comprising: the source configuring the tag such that, when the tag is read, a responsive action is initiated.

2. The method as claimed in claim 1 and wherein the responsive action is detectable by the source.

3. The method as claimed in claim 1, wherein information is provided concerning delivery of a physical object from the source to a destination, including the source associating the tag with the physical object, the tag being configured such that, when the tag is read at the destination, it causes a responsive action, the responsive action being detectable by the source.

4. The method as claimed in claim 1, wherein the source configures the tag via a remote access.

5. The method as claimed in claim 1, wherein the responsive action is directed to the source.

6. The method as claimed in claim 1, wherein the responsive action is directed to a location other than the source and the location is accessible by the source.

7. The method as claimed in claim 1, wherein the responsive action is at least one of:
an acknowledgement of receipt of the tag at a destination;
sending information about the location where the tag has been read;
informing the source that the tag has been read;
informing a destination that the tag has been read;
displaying a message to a person reading the tag.

8. The method as claimed in claim 1, wherein the source configures the tag with information that includes at least one of:
information about the source;
information about the context of the tag; and
information about a destination.

9. The method as claimed in claim 1, wherein the source configures the tag such that, when the tag is read, a responsive action is initiated, and the responsive action is dependent on the identify of an entity reading the tag.

10. The method as claimed in claim 1, wherein the tag is configured to be read by a mail delivery system.

11. The method as claimed in claim 1, wherein the tag is configured with a communication link that may be activated by an intended recipient.

12. The method as claimed in claim 1, wherein the tag is configurable online.

13. The method as claimed in claim 1, wherein the tag is an RFID tag.

14. A tag for use with the method as claimed in claim 1.

15. A home gateway for implementing the method as claimed in claim 1.
